(19) United States
(12) Patent Application Publication
(10) Pub. No.: US 2024/0116447 A1
(43) Pub. Date: Apr. 11, 2024

(54) Walk-In Cab Chassis

(71) Applicant: The Shyft Group, Inc., Charlotte, MI (US)

(72) Inventor: Eric R. Fisher, Elkhart, IN (US)

(21) Appl. No.: 18/483,053

(22) Filed: Oct. 9, 2023

Related U.S. Application Data
(60) Provisional application No. 63/414,768, filed on Oct. 10, 2022.

(51) Int. Cl. B60R 3/00

(52) U.S. Cl. CPC B60R 3/002

(57) ABSTRACT

A medium duty commercial vehicle with a walk-in cab chassis and a drivetrain. The walk-in cab chassis includes a pair of chassis rails with a plurality of front wheels and a plurality of rear wheels extending therefrom. The cab chassis includes a cab with interior side steps that are accessible by side doors. The side doors protect the interior side steps from weather elements. The drivetrain is configured to drive one or more of the plurality of front wheels and/or the plurality of rear wheels.

### RELATED APPLICATIONS

This application claims the benefit of U.S. Patent App. Ser. No. 63/414,768 filed Oct. 10, 2022 for a “Walk-in Cab Chassis” which is hereby incorporated by reference in its entirety.

### TECHNICAL FIELD

This disclosure relates generally to cab chassis; in particular, this disclosure relates to a walk-in type cab chassis.

### BACKGROUND AND SUMMARY

A cab chassis is a type of vehicle construction that generally only includes chassis rails and a cab. This can be upfitted with equipment according to a customer's needs. For example, a cab chassis can be customized into a variety of work vehicles, such as a stake bed truck, a flatbed truck, a reefer/refrigerated truck, a service body truck, etc. Typically, cab chassis are within the medium duty market, which includes Classes 3-6 in the United States.

Although work vehicles upfit from cab chassis are generally acceptable for their purpose, challenges can arise. For example, FIGS. 1-4 illustrate portions of trucks 100 built from prior art cab chassis. As is typical, there can be one or two external steps 102 that must be climbed for the driver to enter the cab 104. These external steps 102 are exposed to the elements, such as rain, sleet, and snow and can be a falling hazard to the driver entering the cab 104. Another potential issue is seen in FIGS. 2-4, in which the truck's 100 door(s) 106 are open. The driver must be careful when opening the door(s) 106 to traffic as the door swings outwardly and may create an accident. Another challenge to existing designs is the cab interior, which is typically laid out like a pickup truck. This type of cab interior generally lacks flexibility in seating and storage layouts.

Accordingly, there is a need for a new cab chassis that addresses one or more of these shortcomings. In some embodiments, this disclosure provides a medium duty commercial vehicle with a walk-in cab chassis and a drivetrain. The walk-in cab chassis includes a pair of chassis rails with a plurality of front wheels and a plurality of rear wheels extending therefrom. The cab chassis includes a cab with interior side steps that are accessible by side doors. The side doors protect the interior side steps from weather elements. The drivetrain is configured to drive one or more of the plurality of front wheels and/or the plurality of rear wheels.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIGS. 1-4 are perspective views of work trucks built on prior art cab chassis;

FIG. 5 is a front perspective view of an example cab chassis according to an embodiment of this disclosure;

FIG. 6 is a rear perspective view of the example cab chassis shown in FIG. 5;

FIG. 7 is a front perspective of an example cab with the roof cutaway and the doors in a closed position according to an embodiment of this disclosure;

FIG. 8 is a top view of an example cab with the roof cutaway and the doors in an open position according to an embodiment of this disclosure;

FIG. 9 is a right side detailed perspective view of an example cab with the roof and doors cutaway according to an embodiment of this disclosure;

FIG. 10 is a front perspective view of example seats in the extended position that may be used in the cab according to an embodiment of this disclosure;

FIG. 11 is a side view of an example seat in the retracted position that may be used in the cab according to an embodiment of this disclosure;

FIG. 12 is a right side view of an example stake bed truck built on a cab chassis according to an embodiment of this disclosure;

FIG. 13 is a right side view of an example flatbed truck built on a cab chassis according to an embodiment of this disclosure;

FIG. 14 is a right side view of an example refrigerated truck built on a cab chassis according to an embodiment of this disclosure; and

FIG. 15 is a right side view of an example bucket truck built on a cab chassis according to an embodiment of this disclosure.

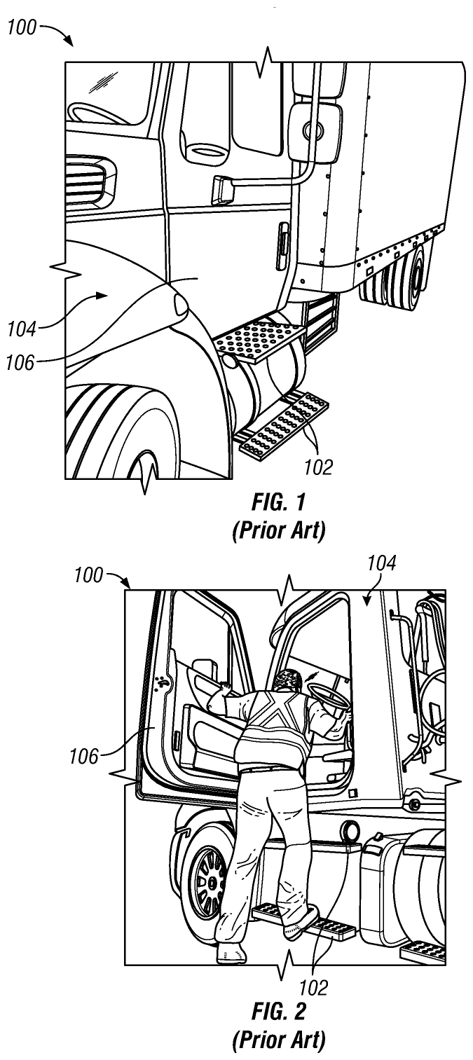

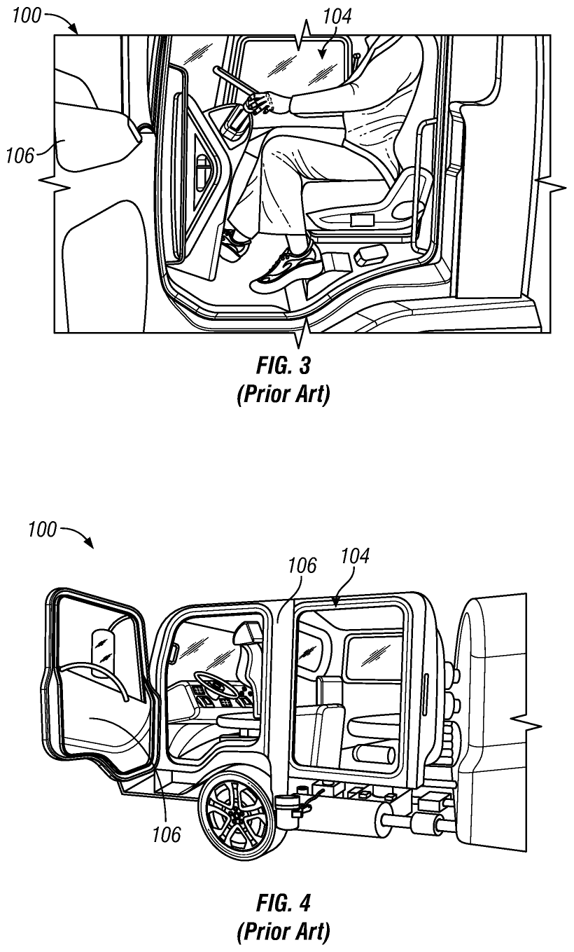

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

In the drawings, some structural features may be shown in specific arrangements. However, it should be appreciated that such specific arrangements may not be required. Rather, in some embodiments, such features may be arranged in a different manner than shown in the illustrative figures. Additionally, the inclusion of a structural in a particular figure is not meant to imply that such feature is required in all embodiments and, in some embodiments, may not be included or may be combined with other features.

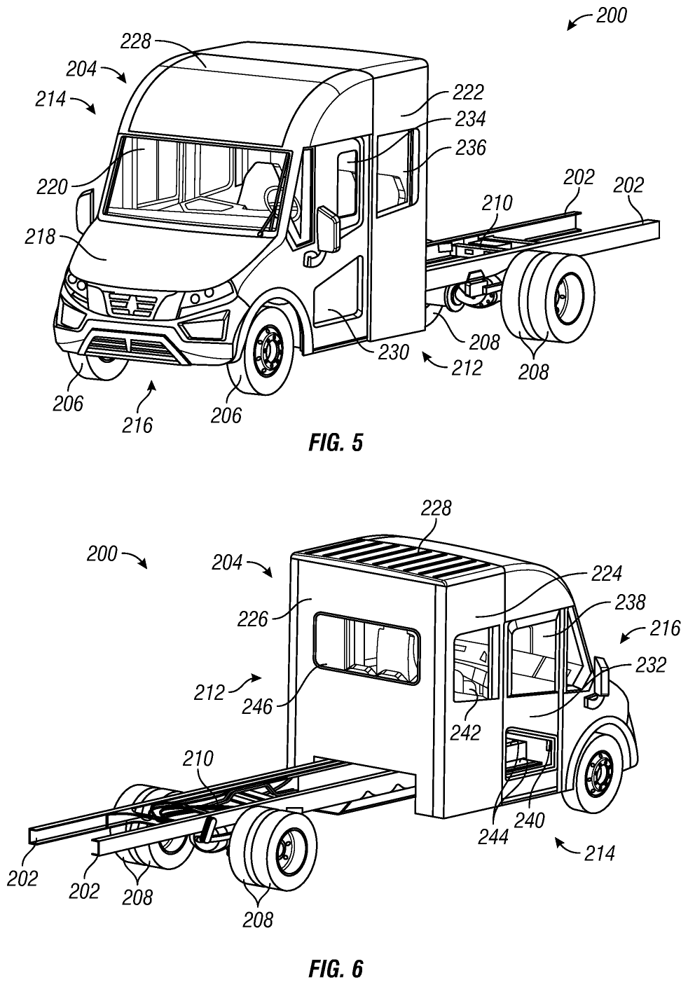

Referring to FIGS. 5 and 6, this disclosure relates generally to a walk-in cab chassis 200. As shown, the walk-in cab chassis 200 includes chassis rails 202 and a cab 204. There are front wheels 206 and rear wheels 208 that extend along the rails 202. Depending on the circumstances, the walk-in cab chassis 200 could include a drivetrain 210 that drives the rear wheels and/or front wheels. Although the example walk-in cab chassis 200 is shown with an electronic drivetrain 210, the walk-in cab chassis 200 could be an electronic vehicle (EV), an internal combustion engine (ICE) vehicle and/or a hybrid vehicle.

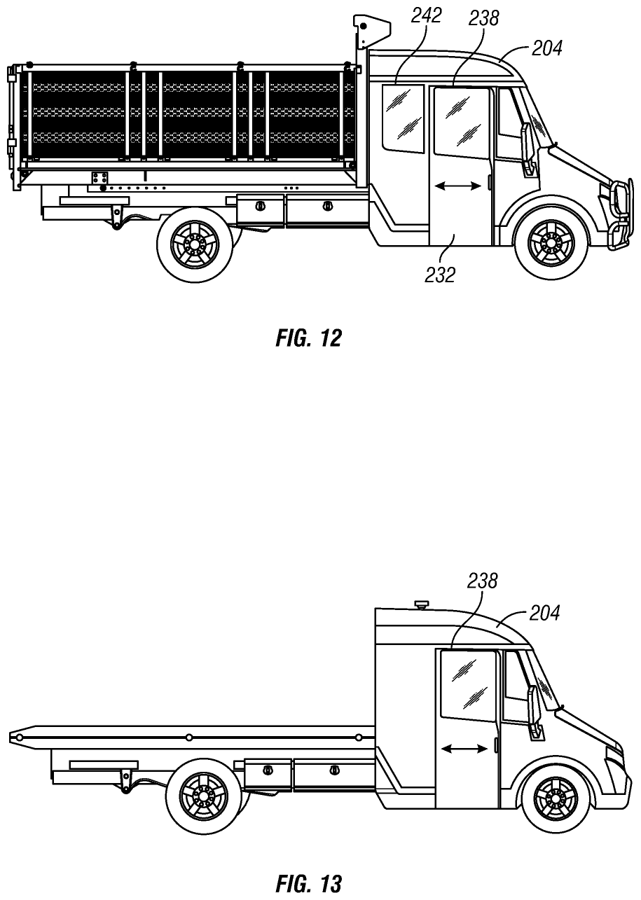

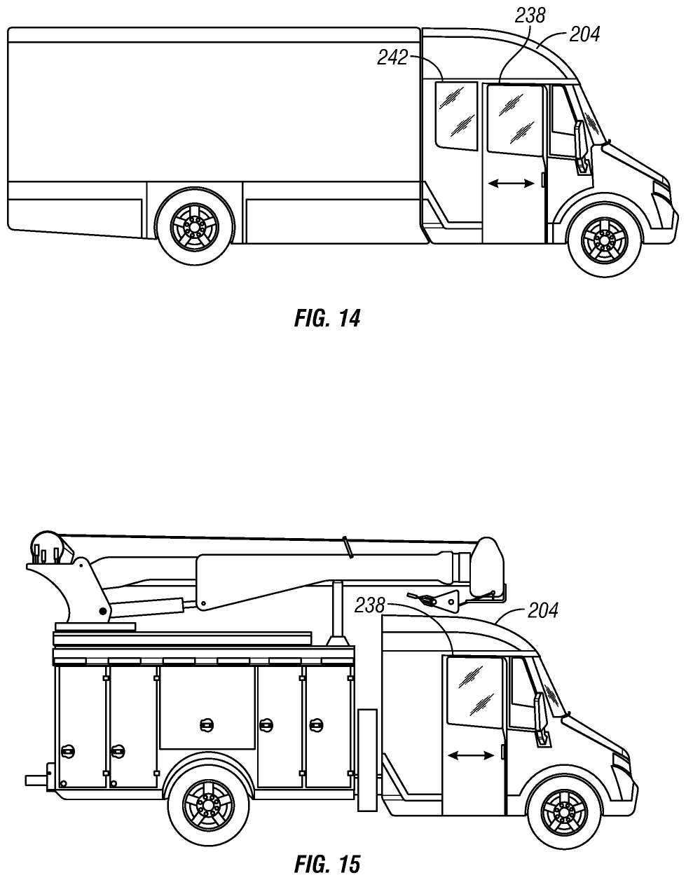

In some embodiments, the walk-in cab chassis 200 is a medium duty vehicle, which would correspond with Classes 3-6 in the United States. The walk-in cab chassis 200 could be upfit into a variety of work vehicles using techniques currently in the art to upfit work vehicles. By way of example only, the walk-in cab chassis 200 could be upfit into a stake bed truck (FIG. 12), a flatbed truck (FIG. 13), a reefer/refrigerated truck (FIG. 14), a service body truck (FIG. 15), etc. These work trucks are merely provided as examples and are not intended to be limiting on the type of work vehicles provided by this disclosure. The walk-in cab chassis 200 could be upfit into any type of work vehicles and/or other customized commercial vehicles.

The example cab 204 includes a driver's side 212 and a passenger's side 214. As shown, the cab 204 includes a front portion 216 with a hood 218 extending upwardly to a windshield 220. The cab 204 includes a driver's side wall 222, a passenger's side wall 224, a rear wall 226, and a roof 228. There is a driver's side door 230 (FIG. 5) that provides access to the interior of the cab 204 from the driver's side 212. Likewise, there is a passenger's side door 232 (FIG. 6) that provides access to the interior of the cab 204 from the passenger's side 214. In the embodiment shown, the driver's side door 230 and the passenger's side door 232 are slidable between open and closed positions. For example, the driver's side wall 222 and passenger's side wall 224 may include integral track systems along which the respective doors 230, 232 slide. With the doors 230, 232 sliding between open/closed positions, the vehicle may be driven with the doors 230, 232 open without increasing the risk of an accident from swinging doors.

In the example shown, the driver's side door 230 includes a window 234 and the driver's side wall 222 includes a window 236. In some embodiments, when the driver's side door 230 slides to an open position, the window 234 is generally aligned with the window 236. This allows the door 230 to be opened without obstructing the view from any passengers sitting in the back seat(s) of the cab 204 from seeing through the window 236.

As shown, the passenger's side door 232 includes an upper window 238 and a lower window 240. In the embodiment shown, the passenger's side wall 224 also includes a window 242. In some embodiments, when the passenger's side door 232 slides to an open position, the upper window 238 is generally aligned with the window 240. This allows the door 232 to be opened without obstructing the view from any passengers sitting in the back seat(s) of the cab 204 from seeing through the window 242.

In the embodiment shown, the cab 204 includes one or more side steps 243 (FIG. 8) on the driver's side 212 that the driver uses to climb into/out of the interior of the cab 204 from the driver's side 212. Likewise, there are one or more side steps 244 (FIGS. 6-9) on the passenger's side 214 that the driver uses to climb into/out of the interior of the cab 204 from the passenger's side 214. As shown, the side steps 243, 244 are protected from the weather elements by the doors 230, 232. This is a safety improvement over existing cab chassis with external steps that are exposed to weather elements, and thereby can become a falling hazard. In the embodiment shown, the lower window 240 provides visibility to the ground outside the passenger's side 214 of the cab 204. In the embodiment shown, the rear wall 226 includes a window 246.

In some embodiments, the cab 204 has a width of approximately 88.5 inches. Embodiments are also contemplated in which the cab 204 has a width of approximately 93 inches or approximately 96 inches depending on the circumstances. Other widths greater than 88.5 inches are also possible. These embodiments are substantially wider than existing cab chassis designs, which are typically about 80.8 inches (e.g., GMC 3500 chassis cab width). The wider cab in this embodiment provides additional interior space compared to existing chassis cab designs. In some embodiments, the cab 204 may have a headroom height of approximately 85 inches. This provides enough headroom for the driver to walk into the cab 204. Additionally, this provides improved ergonomics and easier access to the cab 204 compared to existing chassis cab designs.

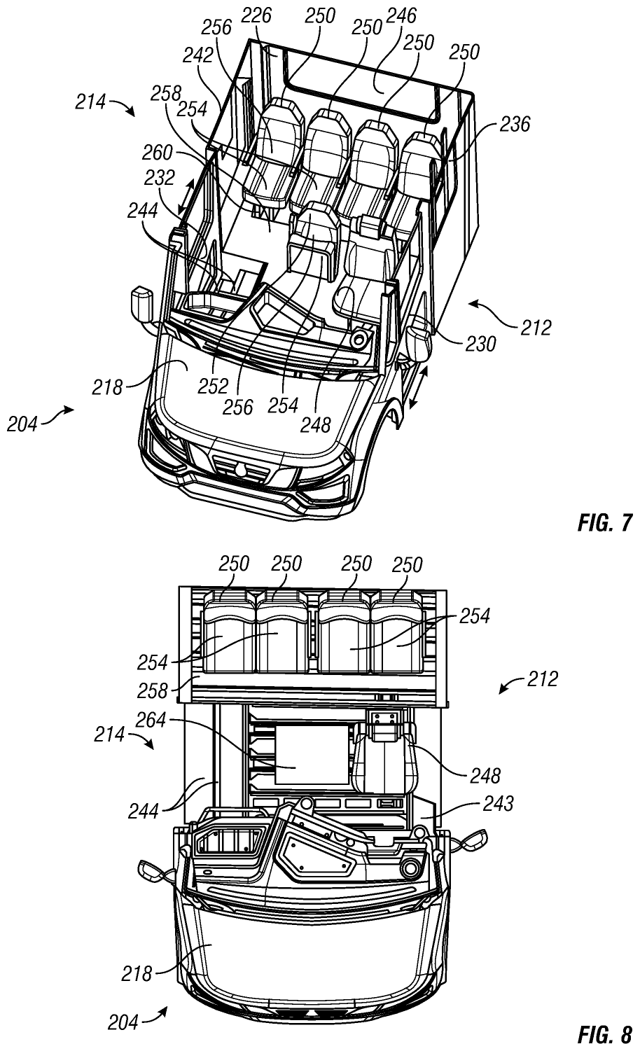

Referring now to FIG. 7, there is shown an interior view of the example cab 204. In this example, there is a driver's seat 248, which can be accessed by a side step 243 (FIG. 8) that is protected from the weather elements by the driver's side door 230. There could be a variety of different arrangements of seats and storage areas. Depending on the circumstances, there could be a front row with the driver's seat and a back row with a plurality of seats 250 and/or storage areas. In some cases, there could be a middle row with additional seats 252 and/or storage areas and/or other accessories.

In some embodiments, the seats 248, 250, and/or 252 include a seat portion 254 and a back portion 256. The seat portion 254 may be suspended above a floor 258 on a platform 260. In some embodiments, the platform 260 may be formed from a single leg (FIG. 10) or multiple legs (FIG. 7). Depending on the circumstances, the platform 260 could be detachably connected to the floor 258 to change the arrangement of the interior. In some embodiments, the seat portion 254 is pivotable with respect to the back portion 256. For example, the seat portion 254 could be pivoted to an approximately vertical position (FIGS. 7, 11) to be stowed out of way when not in use. When the seat portion 254 is needed, the seat portion 254 can be pivoted back to a horizontal position for seating.

In the example shown, the floor 258 is flat throughout between the front row, optional middle row, and back row. This provides good ergonomics for a driver (or other persons) to move about the interior of the cab 204 without needing to navigate height changes or height variations of the floor 258.

Also seen in FIG. 7 are the side steps 244 on the passenger side 214. As can be seen, the side steps 244 are protected by the passenger's side door 232 from the weather elements. As discussed herein, this is a safety feature so the side steps 244 do not become icy from snow or sleet, or become wet from rain.

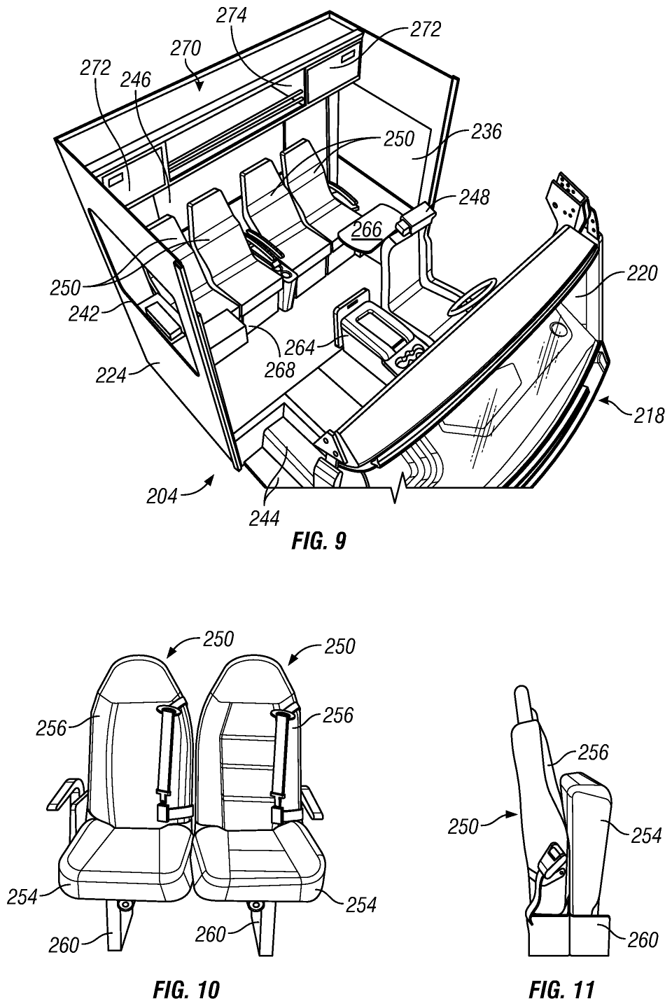

Referring to FIG. 8, there is shown an arrangement of the cab 204 interior with a driver's seat 248 on a front row with a console 264. In the embodiment shown, there are a plurality of seats 250 in a back row. As discussed herein, in some embodiments, the seat portion 254 of the seats 250 could be pivoted to a vertical position to provide additional space within the interior of the cab 204. FIG. 9 shows an embodiment with an arrangement similar to FIG. 8. As seen, there could be other accessories, such as a table 266. In some cases, there could be storage bins 268 underneath the seats 250. In the embodiment shown, there is a storage unit 270 with cabinets 272 and a cubby 274 along the rear wall 226.

FIGS. 12-15 illustrate a variety of example work trucks that could be upfit from the cab chassis 200. FIG. 12 shows an example stake bed truck; FIG. 13 illustrates an example a flatbed truck; FIG. 14 illustrates an example reefer/refrigerated truck; FIG. 15 illustrates an example a service body truck. Although FIGS. 12-15 illustrate certain work trucks that could be upfit from the cab chassis 200 according to an embodiment, this disclosure is not limited to the work trucks shown. The cab chassis 200 could be upfit or customized into a wide variety of work trucks and/or other commercial trucks and each of these is encompassed by this disclosure.

1. A commercial vehicle comprising:
a walk-in cab chassis comprising:
a pair of chassis rails with a plurality of front wheels and a plurality of rear wheels extending therefrom;
a cab with interior side steps that are accessible by side doors, wherein the side doors protect the interior side steps from weather elements;
a drivetrain configured to drive one or more of the plurality of front wheels and/or the plurality of rear wheels; and
wherein the walk-in cab chassis is configured as a medium duty truck.

2. The commercial vehicle of claim 1, wherein the medium duty truck corresponds with one or more of commercial truck classes 3, 4, 5, or 6.

3. The commercial vehicle of claim 2, wherein the walk-in chassis is upfit as one or more of a stake bed truck, a flatbed truck, a refrigerated truck, or a service body truck.

4. The commercial vehicle of claim 1, wherein the cab includes a driver's side with a driver's side wall, a passenger's side with a passenger's side wall, a front portion with a hood extending upwardly to a windshield, a rear wall, and a roof, wherein a driver's side door provides access to an interior of the cab from the driver's side and a passenger's side door provides access to the interior of the cab from the passenger's side.

5. The commercial vehicle of claim 4, wherein the passenger's side door is slidable between an open and closed position and the driver's side door is slidable between an open and closed position.

6. The commercial vehicle of claim 5, wherein the driver's side door provides access to a driver's seat within the interior of the cab.

7. The commercial vehicle of claim 5, wherein the drivetrain is configured to drive one or more of the plurality of front wheels and/or the plurality of rear wheels while the driver's side door and/or the passenger's side door are in the open position.

8. The commercial vehicle of claim 5, wherein the driver's side door includes a window and the driver's side wall includes a window, wherein when the driver's side door 230 slides to an open position, the window 234 in the driver's side wall is generally aligned with the window in the driver's side door.

9. The commercial vehicle of claim 8, wherein the passenger's side door includes an upper window and a lower window, and wherein the passenger's side wall includes a window.

10. The commercial vehicle of claim 9, wherein when the passenger's side door slides to an open position, the upper window is generally aligned with the window in the passenger's side wall.

11. The commercial vehicle of claim 10, wherein the cab includes one or more side steps on the driver's side that are arranged to provide ingress and egress into/out of the interior of the cab from the driver's side, wherein the one or more side steps are within the interior of the cab.

12. The commercial vehicle of claim 11, wherein the cab includes one or more side steps on the passenger's side that are arranged to provide ingress and egress into/out of the interior of the cab from the passenger's side, wherein the one or more side steps are within the interior of the cab.

13. The commercial vehicle of claim 12, wherein the lower window is arranged on the passenger's side door to provide visibility to an egress point outside adjacent the passenger's side of the cab.

14. The commercial vehicle of claim 2, wherein the cab has a width of approximately 88.5 inches, 93 inches or 96 inches.

15. The commercial vehicle of claim 2, wherein the cab has an interior with a ceiling above a floor to provide enough headroom within the interior for a driver to stand within an interior of the cab.

16. The commercial vehicle of claim 15, wherein the floor within the interior of the cab is flat between the interior side steps.

17. The commercial vehicle of claim 16, wherein the interior of the cab includes a front row with a driver's seat and a back row with a plurality of seats.

18. The commercial vehicle of claim 17, wherein the plurality of seats include a seat portion that pivots between a horizontal position for sitting and a vertical portion to provide additional space.

19. The commercial vehicle of claim 18, further comprising one or more storage units positioned underneath the plurality of seats in the back row.

20. The commercial vehicle of claim 19, wherein the one or more storage units include one or more of a cabinet and/or a cubby along a rear wall of the cab.
